(19) United States
(12) Patent Application Publication
(10) Pub. No.: US 2025/0084283 A1
(43) Pub. Date: Mar. 13, 2025

(54) ADHESIVE TAPE, ARTICLE OBTAINED USING ADHESIVE TAPE, AND METHOD FOR DISMANTLING ARTICLES

(71) Applicant: DIC Corporation, Tokyo (JP)

(72) Inventor: Kenichi Fujisaki, Saitama (JP)

(73) Assignee: DIC Corporation, Tokyo (JP)

(21) Appl. No.: 18/730,545

(22) PCT Filed: Jan. 19, 2023
(86) PCT No.: PCT/JP2023/001428

§ 371 Date: Jul. 19, 2024

(30) Foreign Application Priority Data
Feb. 4, 2022 (JP) 2022-016443

(51) Int. Cl. C09J 7/30; C08K 3/22; C08K 3/26; C08K 3/30; C09J 135/02

(52) U.S. Cl. CPC C09J 7/30; C08K 3/30; C09J 135/02; C08K 2003/2227; C08K 2003/262; C08K 2003/3045; C09J 2301/124; C09J 2301/208; C09J 2301/502; C09J 2400/24; C09J 2425/005

(57) ABSTRACT

An object of the present invention is to provide an adhesive tape that has excellent formability, impact resistance, conformability to adherends, and endothermic property, that can be used for fixing two or more adherends, and that can be easily dismantled when the adherends are to be separated, and in particular provide an adhesive tape that can suppress thermal degradation of adherends even when excessive heat is applied and that has excellent heat resistance. The present invention relates to an adhesive tape having an easily dismantlable layer (A) containing a thermoplastic resin, an adhesive layer (B), and a foam layer (C), in which one or more layers of the easily dismantlable layer (A), the adhesive layer (B), and the foam layer (C) contain one or more heat-absorbing agents.

### TECHNICAL FIELD

The present invention relates to an easily dismantlable adhesive tape which is attached to adherends or used to fix articles and then can be easily taken off from the adherends or allows the fixed articles to be easily dismantled after a certain period of time.

### BACKGROUND ART

Double-sided adhesive tapes having impact resistance are used to fix protective panels of image displays that constitute electronic devices such as portable electronic terminals, cameras, and personal computers, to housings, and to fix parts such as exterior parts and batteries to the electronic devices (for example, see PTL 1).

With the trend toward thinner and more sophisticated electronic devices, thin parts made of rigid materials, such as protective panels, image display modules, and touch panels for image displays, and thin batteries, tend to be frequently used. These parts are expensive, and it is desirable that they can be easily separated and dismantled from the main bodies (housings) of the electronic devices or the like, for example, when the electronic devices malfunction, and that the separated parts, the main bodies of the electronic devices, and the like can be reused or recycled. In this respect, double-sided adhesive tapes are required not only to serve to stably fix parts and the like but also to impart the characteristics of easily dismantling the parts and the like when it is desired to separate them.

For example, a pressure-sensitive adhesive tape including a pressure-sensitive adhesive layer containing a blowing agent expandable by heating (see PTL 2) and an adhesive tape including an easily dismantlable layer having a thermoplastic resin as a component (see PTL 3) have been proposed. These adhesive tapes enable separation of adherends by heating.

### CITATION LIST

### Patent Literature

PTL 1: Japanese Unexamined Patent Application Publication No. 2010-260880
PTL 2: Japanese Unexamined Patent Application Publication No. 2013-79322
PTL 3: Japanese Unexamined Patent Application Publication No. 2016-79361

### SUMMARY OF INVENTION

### Technical Problem

However, when an adhesive tape that allows adherends to be separated by heating is used, the adherend itself may be degraded by heat if excessive heat is applied to separate and dismantle the adherend such as the main body of an electronic device or an expensive and precise electronic part as described above. In addition, heat may cause the adhesive tape to produce smoke. There is still room for improvement in these points.

An object of the present invention is to provide an adhesive tape that has excellent formability, impact resistance, conformability to adherends, and endothermic property, that can be used for fixing two or more adherends, and that can be easily dismantled when the adherends are separated, and in particular provide an adhesive tape that can suppress thermal degradation of adherends even when excessive heat is applied and that has excellent heat resistance.

Another object of the present invention is to provide an article having a configuration in which two or more adherends are fixed by such an adhesive tape, and a method for dismantling an article in which two or more adherends that constitute the article are separated by heating.

### Solution to Problem

The present invention relates to the following (1) to (10).

(1) An adhesive tape having an easily dismantlable layer (A) containing a thermoplastic resin, an adhesive layer (B), and a foam layer (C), wherein one or more layers of the easily dismantlable layer (A), the foam layer (C), and the adhesive layer (B) contain one or more heat-absorbing agents. (2) The adhesive tape according to (1), wherein the foam layer (C) contains one or more heat-absorbing agents. (3) The adhesive tape according to (1) or (2), wherein the adhesive tape has a foam layer (C) and an adhesive layer (b1) directly or with another layer interposed on one side of the easily dismantlable layer (A), and has an adhesive layer (b2) directly or with another layer interposed on the other side of the easily dismantlable layer (A). (4) The adhesive tape according to any one of (1) to (3), wherein the adhesive tape has an adhesive layer (b2) on the other side of the easily dismantlable layer (A) with at least a base film layer (D) interposed. (5) The adhesive tape according to any one of (1) to (3), wherein a foam layer (C) is laminated directly or with another layer interposed on one side of the easily dismantlable layer (A), an adhesive layer (b1) is laminated on a surface of the foam layer (C) with at least one layer of a base film layer (D) and a bonding agent layer (E) interposed, and the adhesive tape has an adhesive layer (b2) with at least one layer of a base film layer (D) and a bonding agent layer (E) interposed on the other side of the easily dismantlable layer (A). (6) The adhesive tape according to any one of (1) to (5), wherein the foam layer (C) has a thickness of 1500 μm or less. (7) The adhesive tape according to any one of (1) to (6), wherein the adhesive tape has a total thickness of 100 μm to 500 μm. (8) An article having a configuration in which two or more adherends are fixed by the adhesive tape according to any one of (1) to (7). (9) A method for dismantling an article, in which two or more adherends that constitute the article are separated by directly or indirectly heating a part or all of an easily dismantlable layer (A) and plasticizing the easily dismantlable layer (A).

### Advantageous Effects of Invention

The present invention can provide an adhesive tape that has excellent formability, impact resistance, conformability to adherends, and endothermic property, that can be used for fixing two or more adherends, and that can be easily dismantled when the adherends are to be separated, and in particular provide an adhesive tape that can suppress thermal degradation of adherends even when excessive heat is applied and that has excellent heat resistance.

### BRIEF DESCRIPTION OF DRAWINGS

FIG. 1 is a cross-sectional view of an exemplary embodiment of an adhesive tape according to the present invention.

FIG. 2 is a cross-sectional view of an exemplary embodiment of an adhesive tape according to the present invention.

FIG. 3 is a cross-sectional view of an exemplary embodiment of an adhesive tape according to the present invention.

FIG. 4 is a cross-sectional view of an exemplary embodiment of an adhesive tape according to the present invention.

FIG. 5 is a DSC curve of a foam base 1 obtained in Example 1.

FIG. 6 is a DSC curve of a foam base 2 obtained in Example 2.

FIG. 7 is a DSC curve of a foam base 3 obtained in Example 3.

FIG. 8 is a DSC curve of a foam base 4 obtained in Example 4.

### DESCRIPTION OF EMBODIMENTS

Embodiments of the present invention will be described in detail below. In the present description, a numerical range indicated using “to” indicates a range that includes the numerical values listed before and after “to” as the minimum and maximum values, respectively. “(Meth)acrylate” is a term that collectively refers to acrylate, methacrylate, and both. “(Meth)acrylic” is a term that collectively refers to acrylic, methacrylic, and both.

The present invention provides an adhesive tape including an easily dismantlable layer (A) containing a thermoplastic resin (hereinafter simply referred to as “easily dismantlable layer (A)”), an adhesive layer (B), and a foam layer (C), in which one or more layers of the easily dismantlable layer (A), the foam layer (C), and the adhesive layer (B) contain one or more heat-absorbing agents.

The adhesive tape of the present invention may be a single-sided adhesive tape for label and other applications easily removable by heating, in which the adhesive layer (B) is provided on only one side, that is, on an outermost layer on one side, or may be a double-sided adhesive tape in which the adhesive layers (B) are provided on the outermost layers on both sides.

The adhesive tape of the present invention, which is in the form of double-sided adhesive tape, can be used for fixing adherends, such as thin parts made of rigid materials, such as protective panels, image display modules, and touch panels for image displays, and thin batteries, to the main bodies (housings) of electronic devices. The adherends can be easily separated and dismantled by directly or indirectly heating a part or all of the easily dismantlable layer (A) and plasticizing the easily dismantlable layer (A).

In this case, in the adhesive tape of the present invention, since one or more layers of the easily dismantlable layer (A), the foam layer (C), and the adhesive layer (B) contain one or more heat-absorbing agents, even when excessive heat is applied to separate two or more adherends fixed by the adhesive tape, such excessive heat is absorbed by the heat-absorbing agent, so that an appropriate temperature for separation and dismantling is held, thereby suppressing thermal degradation of the adherends.

Examples of the heat-absorbing agent include inorganic hydrates, metal hydroxides, and carbonates that preferably have an endothermic peak at a temperature of 80° C. or higher.

Specific examples include calcium sulfate dihydrate, magnesium sulfate heptahydrate, sodium bicarbonate, aluminum hydroxide, magnesium hydroxide, calcium hydroxide, calcium carbonate, hydrotalcite, and zinc borate hydrate. Among these, at least one selected from the group consisting of calcium sulfate dihydrate, sodium bicarbonate, aluminum hydroxide, magnesium hydroxide, and calcium carbonate is preferred, and at least one selected from the group consisting of calcium sulfate dihydrate, sodium bicarbonate, and aluminum hydroxide is more preferred. The heat-absorbing agents may be used singly or in combination of two or more.

The endothermic start temperature of the heat-absorbing agent is preferably in the range of 60° C. to 500° C., more preferably in the range of 80° C. to 400° C., and even more preferably in the range of 80° C. to 300° C.

The endothermic peak temperature of the heat-absorbing agent is preferably in the range of 80° C. to 550° C., more preferably in the range of 100° C. to 450° C., and even more preferably in the range of 100° C. to 350° C.

The endothermic amount of the heat-absorbing agent is preferably in the range of 100 J/g to 1200 J/g, and more preferably in the range of 300 J/g to 1200 J/g.

The endothermic start temperature, the endothermic peak temperature, and the endothermic amount of each heat-absorbing agent are values determined by the method described in the examples described later using a differential scanning calorimeter (DSC).

When two or more heat-absorbing agents are used together, two or more heat-absorbing agents with different endothermic start temperatures or different endothermic peak temperatures may be combined. In this case, the mass ratio of each heat-absorbing agent is not limited and can be set as appropriate.

The particle size of the heat-absorbing agent is preferably in the range of 1 μm to 100 μm, and more preferably in the range of 1 μm to 80 μm. It is advantageous that the particle size of the heat-absorbing agent is within the above range, in terms of facilitating uniform dispersion of the heat-absorbing agent in each of the layers that constitute the adhesive tape of the present invention, and thereby increasing the amount blended.

The particle size of the heat-absorbing agent is the median diameter (D50) value measured by a laser diffraction/scattering particle size distribution analyzer.

One or more layers of the easily dismantlable layer (A), the foam layer (C), and the adhesive layer (B) that constitute the adhesive tape of the present invention contain one or more heat-absorbing agents. Among these, it is preferable that the foam layer (C) contains one or more heat-absorbing agents.

In terms of easily implementing endothermic property, the content of the heat-absorbing agent is preferably in the range of 10% by mass to 95% by mass with respect to all components of the layer, more preferably in the range of 50% by mass to 90% by mass, and more preferably in the range of 65% by mass to 90% by mass.

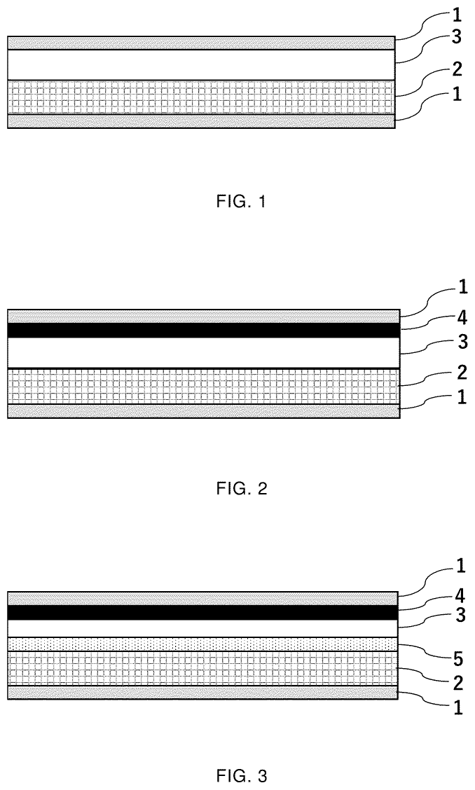

A first embodiment of the adhesive tape of the present invention is, for example, a double-sided adhesive tape in which a foam layer (C) is laminated on one side of an easily dismantlable layer (A), an adhesive layer (b1) is laminated on a surface of the foam layer (C), and an adhesive layer (b2) is laminated on the other side of the easily dismantlable layer (A) (see FIG. 1).

A second embodiment of the adhesive tape of the present invention is, for example, a double-sided adhesive tape in which a foam layer (C) is laminated directly or with another layer interposed on one side of an easily dismantlable layer (A), an adhesive layer (b1) which is a first adhesive layer (B) is laminated on a surface of the foam layer (C), and an adhesive layer (b2) which is a second adhesive layer (B) is laminated on the other side of the easily dismantlable layer (A) with a resin film layer (D) interposed (see FIG. 2 and FIG. 3). In such a second embodiment, one side of the easily dismantlable layer (A) and the foam layer (C) may be laminated directly or may be laminated with a bonding agent layer (E) interposed (see FIG. 3). Providing the bonding agent layer (E) can further improve the adhesiveness between the easily dismantlable layer (A) and the foam layer (C).

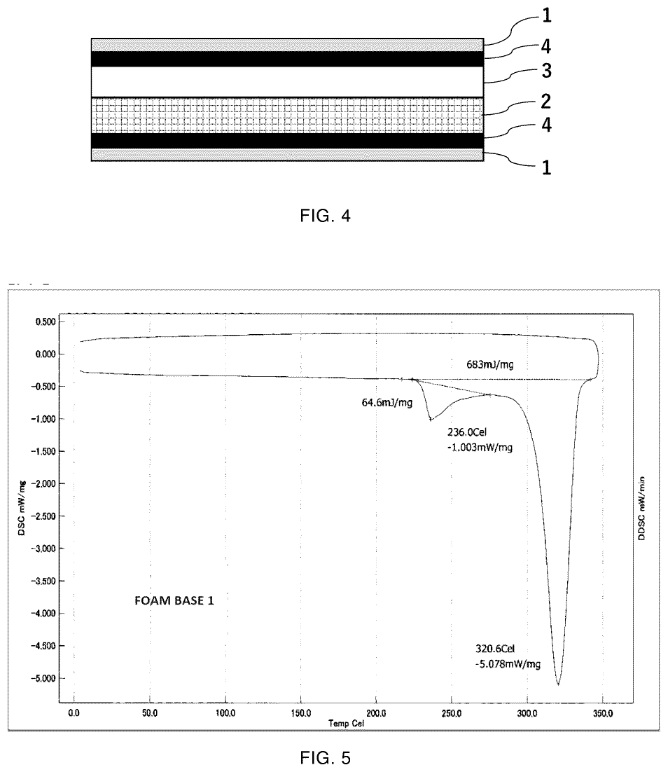

A third embodiment of the adhesive tape of the present invention is, for example, a double-sided adhesive tape in which a foam layer (C) is laminated directly or with another layer interposed on one side of an easily dismantlable layer (A), an adhesive layer (b1) is laminated on a surface of the foam layer (C) with at least one layer of a resin film layer (D) and a bonding agent layer (E) interposed, and an adhesive layer (b2) is laminated on the other side of the easily dismantlable layer (A) with at least one layer of a resin film layer (D) and a bonding agent layer (E) interposed (see FIG. 4).

It is preferable that the adhesive tape of the present invention has the resin film layer (D) at the aforementioned predetermined position, because if so, a portion of the adhesive tape remaining on the surface of two or more adherends can be easily removed after the adherends are separated. Among these, in the adhesive tape of the present invention (double-sided adhesive tape) in which a foam layer (C) is laminated with a bonding agent layer (E) interposed on one side of an easily dismantlable layer (A), the bonding agent layer (E), a resin film layer (D), and an adhesive layer (b1) are laminated in sequence on a surface of the foam layer (C), and an adhesive layer (b2) is provided on the other side of the easily dismantlable layer (A) with a resin film layer (D) interposed, the residual of the adhesive tape can be easily removed from the surface of two or more adherends after the adherends are separated.

It is also preferable that the adhesive tape of the present invention has a bonding agent layer (E) at the aforementioned predetermined position, because if so, the adhesiveness between the layers can be improved.

The present invention is not limited to these configurations, and any other configuration may be added or theses configurations may be replaced with any configuration that performs similar functions.

The adhesive tape of the present invention has a total thickness of preferably in the range of 100 μm to 500 μm, and more preferably in the range of 100 μm to 300 μm, in terms of compatibility between adaptation to thinner electronic devices and good attaching workability.

In the adhesive tape of the present invention, the thickness of the adhesive layer (B) is preferably in the range of 5 μm to 100 μm, more preferably in the range of 10 μm to 80 μm, and even more preferably in the range of 10 μm to 50 μm, in terms of being able to fix the adherend before heating.

In the following, the layers that constitute the adhesive tape of the present invention (which hereinafter may be referred to as “the present adhesive tape”) will be described.

### [Easily Dismantlable Layer (A)]

The easily dismantlable layer (A) that constitutes the present adhesive tape contains a thermoplastic resin. The easily dismantlable layer (A) is a layer that is broken by a peel stress such as by pulling adherends bonded together by the present adhesive tape apart when the adherends are separated from each other. The easily dismantlable layer (A) can be formed, for example, by applying and drying a composition containing a thermoplastic resin on a surface of a release sheet or the like.

Examples of the thermoplastic resin include urethane resins; polycarbonate; vinyl chloride resins such as polyvinyl chloride and vinyl chloride-vinyl acetate copolymer resins; acrylic resins such as polyacrylic acid, polymethacrylic acid, methyl polyacrylate, methyl polymethacrylate, and ethyl polymethacrylate; polyester resins such as polyethylene terephthalate, polybutylene terephthalate, polytrimethylene terephthalate, polyethylene naphthalate, and polybutylene naphthalate; polyamide resins; polystyrene resins such as polystyrene, imide modified polystyrene, acrylonitrile-butadiene-styrene copolymer resins (ABS resins), imide modified ABS resins, styrene-acrylonitrile copolymer resins, acrylonitrile-ethylene-propylene-diene-styrene copolymer resins, cellulose resins such as nitrocellulose and cellulose acetate; silicone resins; and fluororesins.

Among these, urethane resins, vinyl chloride resins, polyester resins, polystyrene resins, and polyamide resins are preferred, and styrene resins are more preferred.

Examples of styrene thermoplastic resins include diblock copolymers such as SB (polystyrene-polybutadiene block copolymer), hydrogenated SB (polystyrene-poly(ethylene/butylene) block copolymer); triblock copolymers such as SBS (polystyrene-polybutadiene-polystyrene block copolymer), hydrogenated SBS (polystyrene-poly(ethylene/butylene)-polystyrene block copolymer (SEBS)), SIS (polystyrene-polyisoprene-polystyrene block copolymer), hydrogenated SIS (polystyrene-poly(ethylene/propylene)-polystyrene block copolymer) (SEPS)), and SIBS (polystyrene-polyisobutylene-polystyrene block copolymer); tetrablock copolymers such as SBSB (polystyrene-polybutadiene-polystyrene-polybutadiene block copolymer); pentablock copolymers such as SBSBS (polystyrene-polybutadiene-polystyrene-polybutadiene-polystyrene block copolymer); multi-block copolymers with more blocks; hydrogenated styrene random copolymers such as styrene-butadiene rubber (SBR) in which ethylene double bond is hydrogenated. Commercially available products may be used as these styrene thermoplastic resins.

In terms of fixing adherends well together under normal conditions, it is preferable that the storage modulus G₂₃ of the thermoplastic resin constituting the easily dismantlable layer (A), as determined by a dynamic viscoelasticity spectrum at 1 Hz and 23° C., is in the range of 1.0×10³ Pa to 5.0×10⁷ Pa, more preferably in the range of 5.0×10³ Pa to 5.0×10⁶ Pa, and even more preferably in the range of 5.0×10³ Pa to 1.0×10⁶ Pa.

In terms of easily separating adherends from each other by heating, it is preferable that the storage modulus G₁₀₀ of the thermoplastic resin constituting the easily dismantlable layer (A), as determined by a dynamic viscoelasticity spectrum at 1 Hz and 100° C., is preferably in the range of 1.0×10² Pa to 5.0×10⁶ Pa, more preferably in the range of 5.0×10³ Pa to 1.0×10⁶ Pa, and even more preferably in the range of 5.0×10³ Pa to 5.0×10⁵ Pa.

It is preferable that the storage modulus G₁₀₀ of the thermoplastic resin contained in the easily dismantlable layer (A) is smaller than the storage modulus G₂₃. G₂₃ and G₁₀₀ can be measured by a commercially available viscoelasticity tester by the method in the examples described later, using a 2-mm thick test piece formed from the thermoplastic resin constituting the easily dismantlable layer (A). The test piece used for the measurement can be prepared, for example, by applying the thermoplastic resin contained in the easily dismantlable layer (A) on a sheet.

The thickness of the easily dismantlable layer (A) is preferably 5 μm to 80 μm, more preferably 5 μm to 60 μm, and even more preferably 10 μm to 20 μm. Here, the thickness of the easily dismantlable layer (A) means the average value obtained by measuring the thickness at five randomly selected locations. When the thickness of the easily dismantlable layer (A) is within the above range, layer formation is easy and dismantling property is excellent.

The easily dismantlable layer (A) may further contain, in addition to the thermoplastic resin, the aforementioned heat-absorbing agent and other additives.

### [Adhesive Layer (B)]

The present adhesive tape is a double-sided adhesive tape having an adhesive layer (b1) and an adhesive layer (b2) as the adhesive layer (B) preferably on the outermost layers on both sides. The adhesive layer (b1) and the adhesive layer (b2) are layers bonded to adherends. The adhesive layer (b1) and the adhesive layer (b2) may have the same adhesive strength or may have different adhesive strengths. Specifically, one of the adhesive layer (b1) and the adhesive layer (b2) may be a strong adhesive layer and the other may be a weak adhesive layer. The adhesive layer (b1) and the adhesive layer (b2) may have the same composition or may have different compositions.

Examples of an adhesive that can form the adhesive layer (B) include those containing resins such as natural rubber, synthetic rubber, acrylic resin, silicone resin, urethane resin, and vinylether resin, as binders. Such an adhesive may be in any form such as solvent based, emulsion type, water based, hot melt, or solvent free type, such as UV, electron beam, or other active energy ray curable type.

Among these, in terms of forming the adhesive layer (B) with a predetermined tensile strength in the present adhesive tape, it is preferable to use a resin containing an acrylic polymer as the adhesive that forms the adhesive layer (B).

As the acrylic polymer, for example, a polymer obtained by polymerizing a vinyl monomer component containing a vinyl monomer such as a vinyl monomer having a hydroxyl group, a vinyl monomer having an acidic group, or an alkyl (meth)acrylate is preferred.

Examples of the vinyl monomer having a hydroxyl group include (meth)acrylic monomers having a hydroxyl group, such as 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 2-hydroxyhexyl (meth)acrylate, 6-hydroxyhexyl (meth)acryl, 8-hydroxyoctyl (meth)acrylate, 10-hydroxydecyl (meth)acrylate, and 12-hydroxylauryl (meth)acrylate. Among these, in terms of obtaining the present adhesive tape with compatibility among even more excellent static load holding strength, impact resistance, dismantling property, and removability, 4-hydroxybutyl (meth)acrylate is preferred and 4-hydroxybutyl acrylate is more preferred.

The vinyl monomer having a hydroxyl group is preferably in the range of 0.01% by mass to 10% by mass of the total amount of the vinyl monomer component, more preferably in the range of 0.01% by mass to 5% by mass, even more preferably in the range of 0.01% by mass to 1% by mass, further more preferably in the range of 0.01% by mass to 0.2% by mass, particularly preferably in the range of 0.01% by mass or more and less than 0.1% by mass, and extremely preferably in the range of 0.02% by mass to 0.08% by mass in terms of obtaining the present adhesive tape with compatibility among even more excellent static load holding strength, impact resistance, dismantling property, and removability.

Examples of the vinyl monomer having an acidic group include (meth)acrylic monomers having a carboxyl group, such as acrylic acid, methacrylic acid, carboxyethyl (meth)acrylate, and carboxypentyl (meth)acrylate; vinyl monomers having a sulfonic acid group, such as (meth)acrylamido propanesulfonic acid, sulfopropyl (meth)acrylate, (meth)acryloyloxynaphthalene sulfonic acid, sodium vinyl sulfonate, styrenesulfonic acid, allylsulfonic acid, 2-(meth)acrylamido-2-methylpropanesulfonic acid, and (meth)acrylamidopropanesulfonic acid; (meth)acrylic monomers having a phosphoric acid group, such as 2-hydroxyethyl acryloyl phosphate; carboxylic acids having a carbon-carbon double bond, such as (anhydrous) itaconic acid, (anhydrous) maleic acid, fumaric acid, and crotonic acid. Among these, (meth)acrylic monomers having a carboxyl group are preferred, and acrylic acid or methacrylic acid is more preferred in terms of obtaining the present adhesive tape with compatibility among even more excellent static load holding strength, impact resistance, dismantling property, and removability.

The vinyl monomer having an acidic group is preferably in the range of 1% by mass to 30% by mass of the total amount of the vinyl monomer component, more preferably in the range of 1% by mass to 15% by mass, even more preferably in the range of 1% by mass to 7% by mass, and particularly preferably in the range of 2.5% by mass to 7% by mass in terms of obtaining the present adhesive tape with compatibility among even more excellent static load holding strength, impact resistance, dismantling property, and removability.

Examples of the alkyl (meth)acrylate include methyl (meth)acrylate, ethyl (meth)acrylate, n-butyl (meth)acrylate, s-butyl (meth)acrylate, t-butyl (meth)acrylate, isobutyl (meth)acrylate, hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-undecyl (meth)acrylate, n-dodecyl (meth)acrylate, n-tridecyl (meth)acrylate, and n-tetradecyl (meth)acrylate. Among these, n-butyl (meth)acrylate and 2-ethylhexyl (meth)acrylate are preferred in terms of obtaining the present adhesive tape with compatibility among even more excellent static load holding strength, impact resistance, dismantling property, and removability.

The alkyl (meth)acrylate is preferably in the range of 50% by mass to 98% by mass of the total amount of the vinyl monomer component, more preferably in the range of 60% by mass to 98% by mass, and even more preferably in the range of 70% by mass to 96% by mass in terms of obtaining the present adhesive tape with compatibility among even more excellent static load holding strength, impact resistance, dismantling property, and removability.

As the vinyl monomer component that can be used in the production of the acrylic polymer, other vinyl monomers other than those listed above may be used if necessary. Examples of such other vinyl monomers include vinyl monomers having an amide group, an amino group, or an imide group, such as (meth)acrylamide, diethylacrylamide, N-vinylpyrrolidone, N,N-dimethyl(meth)acrylamide, N,N-diethyl(meth)acrylamide, N,N′-methylenebisacrylamide, N,N-dimethylaminopropylacrylamide, N,N-dimethylaminopropylmethacrylamide, diacetoneacrylamide, acryloylmorpholine, aminoethyl (meth)acrylate, N,N-dimethylaminoethyl (meth)acrylate, N,N-dimethylaminopropyl (meth)acrylate, cyclohexylmaleimide, isopropylmaleimide, N-cyclohexylmaleimide, and itaconimide; cyano group-containing monomers such as (meth)acrylonitrile; glycidyl group-containing acrylic monomers such as glycidyl (meth)acrylate, methyl glycidyl (meth)acrylate, and allyl glycidyl ether; styrene monomers such as styrene, chlorostyrene, chloromethylstyrene, and α-methylstyrene; vinyl acetate, vinyl propionate, vinyl laurate, methyl vinyl ether, ethyl vinyl ether, and isobutyl vinyl ether.

It is preferable that the vinyl monomer component is constituted with a mixture of (meth)acrylic monomers, in which the content of monomers other than (meth)acrylic monomers such as vinyl acetate and styrene is 5% by mass or less, preferably 3% by mass or less, more preferably 1% by mass or less.

The acrylic polymer can be produced, for example, by radical polymerization of the aforementioned vinyl monomer component in a batch or separate batches, preferably at 40° C. to 90° C., in the presence of an organic solvent and a polymerization initiator. Examples of the polymerization initiator include peroxides such as hydrogen peroxide, potassium persulfate, sodium persulfate, ammonium persulfate, benzoyl peroxide, and cumene hydroxyperoxide; and azo compounds such as 2,2′-azobis(2-methylbutyronitrile), 2,2′-azobis-(2-aminodipropane) dihydrochloride, 2,2′-azobis-(N,N′-dimethyleneisobutylamidine) dihydrochloride, and 2,2′-azobis{2-methyl-N-[1,1-bis(hydroxymethyl)-2-hydroxyethyl]propionamide}. The amount of polymerization initiator used is preferably in the range of 0.01% by mass to 5% by mass of the total amount of the vinyl monomer component.

It is preferable that the adhesive that can form the adhesive layer (B) contains a solvent in terms of maintaining good coating workability and the like. For example, toluene, xylene, ethyl acetate, butyl acetate, acetone, methyl ethyl ketone, hexane, and the like can be used as the solvent. When an aqueous adhesive composition is formed, water or water-based aqueous solvents can be used.

In addition to the aforementioned acrylic copolymer, the adhesive that can form the adhesive layer (B) may further contain the aforementioned heat-absorbing agent and, if necessary, a tackifier resin, a crosslinking agent, and other additive agents.

Examples of the tackifier resin include various tackifier resins such as rosin-based, polymerized rosin-based, polymerized rosin ester-based, rosin phenol-based, stabilized rosin ester-based, disproportionated rosin ester-based, terpene-based, terpene phenol-based, and petroleum resin-based tackifier resins.

Examples of the crosslinking agent include known crosslinking agents such as isocyanate-based, epoxy-based, aziridine-based, polyvalent metal salt-based, metal chelate-based, keto-hydrazide-based, oxazoline-based, carbodiimide-based, silane-based, and glycidyl (alkoxy) epoxysilane-based crosslinking agents. The crosslinking agent can be used to improve the cohesion of the adhesive layer (B).

Examples of the other additives include known foaming agents, plasticizers, softeners, antioxidants, fillers such as glass and plastic fibers, balloons, beads, and metal powders, colorants such as pigments and dyes, pH adjusters, film-forming aids, leveling agents, thickening agents, water repellents, and defoaming agents. These other additives can be added to the extent that they do not impair the desired effects of the present invention.

### [Foam Layer (C)]

The foam layer (C) has a function of imparting good conformability to the adherend and excellent cushioning property (impact resistance) to the present adhesive tape. When the present adhesive tape is heated and dismantled, the foam layer (C) itself may undergo material fracture or may remain on a surface of one of the adherends with no fracture.

In addition to the above function, the present adhesive tape that contains a heat-absorbing agent in the foam layer (C) has heat-insulating and endothermic properties of the foam itself. Thus, in particular, even when excessive heat is applied to separate and dismantle two or more adherends, the transfer of heat to the adherends can be prevented and thermal degradation of the adherends can be suppressed. The above properties also contribute to improving the heat resistance of the present adhesive tape itself, and can suppress occurrence of smoke or the like caused by excessive heat.

In the present adhesive tape having a configuration in which the foam layer (C) and the adhesive layer (b1) are directly laminated, it is preferable to use a high-strength foam layer (C) as described later, because tearing of the present adhesive tape can be prevented during dismantling and the residue on the surface of the adherend can be easily removed from the surface of the adherend after dismantling. Specifically, when using an adhesive tape with a configuration that does not have the resin film layer (D) between the foam layer (C) and the adhesive layer (b1), it is preferable to use the high-strength foam layer described later.

The thickness of the foam layer (C) is preferably 1500 μm or less, more preferably 1200 μm or less, and even more preferably 500 μm or less in terms of imparting excellent processability and excellent conformability to adherends. The lower limit of the thickness is preferably 50 μm.

The compressive strength at 25% of a foam base is preferably 10 kPa or higher, more preferably 10 kPa to 1000 kPa, more preferably 15 kPa to 700 kPa, and even more preferably 15 kPa to 600 kPa in terms of allowing the present adhesive tape to develop suitable adhesive strength for adherends with uneven shapes or rough surfaces.

Here, the compressive strength at 25% refers to the value obtained by placing an approximately 1-mm thick foam base cut into a 30-mm square, and measuring the strength when the foam base is compressed to approximately 0.25 mm (25% of its original thickness) at a rate of 0.5 mm/min at 23° C. in accordance with JIS K 6767.

The tensile strengths of the foam base in the flow direction and the width direction are each preferably 100 kPa or more, and more preferably 200 kPa to 18000 kPa.

The tensile modulus of one of the flow direction and the width direction with the lower tensile modulus is preferably 100 kPa to 14000 kPa, and more preferably 200 kPa to 18000 kPa 1200 N/cm². In this case, the tensile modulus in the direction with the higher tensile modulus is preferably 300 kPa to 18000 kPa, and more preferably 400 kPa to 16000 kPa.

The tensile elongation at cut in a tensile test is preferably 5% to 1500% in the flow direction, more preferably 30% to 1000%, even more preferably 50% to 950%, and particularly preferably 60% to 800%. When the tensile modulus and the tensile elongation of the foam base are within these ranges, deterioration of the processability and reduction of the attaching workability of the present adhesive tape can be suppressed. Further, interlaminar fracture and tearing of the foam base are less likely to occur when the present adhesive tape is stripped off. Even when interlaminar fracture occurs, the ease of stripping off can be imparted to the present adhesive tape.

The tensile strengths in the flow direction and the width direction of the foam base are the maximum values obtained when the foam sheet cut into a shape of dumbbell 1 is measured using a Tensilon tensile tester at a pulling speed of 500 mm/min at 23° C. and 50% RH in accordance with JIS K 6251.

The average bubble diameters in the flow direction and the width direction of the foam base are preferably in the range of 10 μm to 500 μm, more preferably in the range of 30 μm to 400 μm, and even more preferably in the range of 50 μm to 300 μm. When the average bubble diameters in the flow direction and the width direction of the foam base are in the above range, the present adhesive tape has excellent adhesion and impact resistance. The ratio of the average bubble diameters in the flow direction and the width direction of the foam base (the average bubble diameter in the flow direction/the average bubble diameter in the width direction) is preferably 0.2 to 4, more preferably 0.3 to 3, and even more preferably 0.4 to 1. Within the above ratio range, the flexibility and the tensile strength are less likely to vary in the flow direction and the width direction of the foam base.

The average bubble diameter in the thickness direction of the foam base is preferably in the range of 3 μm to 100 μm, more preferably in the range of 5 μm to 80 μm, and even more preferably in the range of 5 μm to 50 μm. The average bubble diameter in the thickness direction of the foam base is preferably ½ or less of the thickness of the foam base, and more preferably ⅓ or less. When the average bubble diameter in the thickness direction and the ratio to the thickness are in these ranges, the present adhesive tape has excellent impact resistance and easily exhibits excellent adhesiveness in bonding rigid materials together. In addition, the density and the strength of the foam base are easily ensured.

In the foam base, the ratio of the average bubble diameter in the flow direction to the average bubble diameter in the thickness direction (the average bubble diameter in the flow direction/the average bubble diameter in the thickness direction) and the ratio of the average bubble diameter in the width direction to the average bubble diameter in the thickness direction (the average bubble diameter in the width direction/the average bubble diameter in the thickness direction) are both preferably 1 or more, more preferably 3 or more, and even more preferably 4 to 25. When the foam base has such ratios of the average bubble diameter, the present adhesive tape has excellent flexibility in the thickness direction and more excellent adhesiveness even when a rigid material is used as the adherend.

The average bubble diameters in the width direction, in the flow direction, and in the thickness direction of the foam base can be measured as follows. First of all, the foam base is cut into 1 cm in the width direction and 1 cm in the flow direction. Then, a digital microscope (product name “KH-7700” from HiROX Co., Ltd.) is set to 200× magnification to observe a cut surface of the foam base in the width direction or the flow direction. In doing so, all of the bubble diameters of bubbles present in the range of 1.5 mm in the flow direction or the width direction of the cut surface are measured. Then, the range of 1.5 mm is changed, and all of the bubble diameters of bubbles present in the ranges at any 10 locations are measured. The value obtained by calculating the average value of the bubble diameters measured as described above is set as the average bubble diameter.

It is preferable to use a foam base having a closed-cell foam structure as the foam base, because water intrusion or dust from the cut surface of the foam base can be effectively prevented. As the shape of the bubbles forming the closed-cell foam structure, it is preferable that the average bubble diameter in the flow direction or the width direction or both directions is larger than the average bubble diameter in the thickness direction in order to obtain the present adhesive tape with moderate conformability to the adherend and cushioning property.

The apparent density of the foam base is 0.08 g/cm³ to 0.7 g/cm³, preferably 0.1 g/cm³ to 0.65 g/cm³, more preferably 0.2 g/cm³ to 0.65 g/cm³, and particularly preferably 0.3 g/cm³ to 0.6 g/cm³, because it is easy to adjust the compressive strength, the average bubble diameters, and the like to the above ranges and to achieve compatibility between impact resistance and excellent adhesiveness to adherends.

The apparent density is the calculated value obtained by preparing approximately 15 cm³ of the foam base cut into a rectangle of 4 cm×5 cm and measuring the mass of the prepared foam base in accordance with JIS K 6767.

The foam base that can form the foam layer (C) having a thickness in the aforementioned suitable range can be selected as appropriate and used. For example, the foam base has a thickness of preferably 350 μm or less, more preferably 50 μm to 300 μm, even more preferably 50 μm to 250 μm, and particularly preferably 50 μm to 200 μm.

The density, the compressive strength, the tensile strength, and the like of the foam base can be adjusted as appropriate by the material and foam structure of the foam base.

Examples of the material of the foam base include olefin resins, urethane resins, acrylic resins, and other rubber-based resins.

In production of the foam base containing a heat-absorbing agent, an emulsion resin that can form voids by mechanical foaming described later can be preferably used in terms of easily forming a foam structure and easily ensuring porosity. Examples of the emulsion resin include acrylic emulsion resins, urethane emulsion resins, ethylene-vinyl acetate emulsion resins, vinyl chloride emulsion resins, and epoxy emulsion resins. Among these, acrylic emulsion resins are preferred because of their excellent heat resistance and heat-insulating properties.

The average particle size of the emulsion resin is preferably 30 nm to 1500 nm, more preferably 50 to 1000 nm, in terms of coating the above heat-absorbing agent and suitably binding the heat-absorbing agent coated with the resin. The average particle size of the emulsion resin can be defined as the 50% median diameter measured by dynamic light scattering, for example, the 50% median diameter on a volume basis as measured by a Microtrac UPA particle size distribution analyzer available from NIKKISO CO., LTD.

In production of the foam base by chemical foaming described later, it is preferable to use an olefin resin in terms of easily preparing a foam base with a closed-cell foam structure that can suitably conform to the surface unevenness of the adherend and has excellent impact resistance. In other words, it is preferable to use a polyolefin foam as the foam base.

Examples of the olefin resin include polyethylene resins such as linear low-density polyethylene, low-density polyethylene, medium-density polyethylene, high-density polyethylene, ethylene-propylene copolymers, ethylene-α-olefin copolymers containing 50% by mass or more of ethylene, and ethylene-vinyl acetate copolymers containing 50% by mass or more of ethylene; polypropylene, and propylene-α-olefin copolymers containing 50% by mass or more of propylene. These may be used singly or in combination of two or more. Examples of the α-olefin include 1-butene, 1-pentene, 4-methyl-1-pentene, 1-hexene, 1-heptene, and 1-octene.

The foam base using a polyethylene resin as the olefin resin is preferred in terms of having a relatively uniform thickness and more suitable flexibility. The amount of polyethylene resin contained in the olefin resin is preferably 40% by mass or more, more preferably 50% by mass or more, even more preferably 60% by mass or more, and particularly preferably 100% by mass.

A polyethylene resin with a narrow molecular weight distribution obtained by using a metallocene compound as a polymerization catalyst is preferably used as the polyethylene resin. In such a polyethylene resin, the copolymerization ratio of copolymerization components having any molecular weight can be adjusted almost equally, resulting in a substantially uniformly crosslinked polyolefin foam. Thus, the foam base can be easily drawn and made into a uniform thickness.

Polyethylene resins obtained by other production methods may also be used.

The foam base may be colored by including a colorant in terms of obtaining the present adhesive tape with design, light shielding effect, concealing effect, light reflectivity, and light resistance.

For example, when light-shielding effect, concealing effect, and light resistance are imparted to the present adhesive tape, it is preferable to use the foam base colored in black. Examples of a black colorant include carbon black, graphite, copper oxide, manganese dioxide, aniline black, perylene black, titanium black, cyanine black, activated carbon, ferrite, magnetite, chromium oxide, iron oxide, molybdenum disulfide, chromium complex, complex oxide-based black dyes, and anthraquinone-based organic black dyes. These may be used singly or in combination of two or more. Among these, carbon black is preferred in terms of cost, availability, insulation, and heat resistance to withstand the heating temperatures in production of the foam base.

When design, light reflectivity, and the like are imparted to the present adhesive tape, it is preferable to use the foam base colored in white. Examples of a white colorant include titanium oxide, zinc oxide, aluminum oxide, silicon oxide, magnesium oxide, zirconium oxide, calcium oxide, tin oxide, barium oxide, cesium oxide, yttrium oxide, magnesium carbonate, calcium carbonate, barium carbonate, zinc carbonate, aluminum hydroxide, magnesium hydroxide, calcium hydroxide, zinc hydroxide, aluminum silicate, calcium silicate, barium sulfate, calcium sulfate, barium stearate, zinc white, talc, silica, alumina, clay, kaolin, titanium phosphate, mica, gypsum, white carbon, diatomaceous earth, bentonite, lithopone, zeolite, sericite, silicone resin particles, acrylic resin particles, urethane resin particles, and melamine resin particles. These may be used singly or in combination of two or more. Among these, titanium oxide, aluminum oxide, and zinc oxide are preferred in terms of cost, availability, color tone, and heat resistance to withstand the heating temperatures in production of the foam base.

The foam base may further contain, if necessary, other components such as a plasticizer, an antioxidant, a foaming aid, a bubble nucleation adjuster, a heat stabilizer, a flame retardant, an antistatic agent, glass or resin hollow balloons/beads, a filler such as metal powders and metal compounds, a conductive filler, and a heat conductive filler.

In terms of preventing appearance defects such as color unevenness and foaming defects such as excessive or no foaming, it is preferable to produce a masterbatch of a colorant, a thermal decomposition-type foaming agent, a foaming aid, and the like with the polyolefin resin or another thermoplastic resin miscible with the polyolefin resin.

The method of producing the foam base is not limited and can be produced by either mechanical foaming or chemical foaming. When the foam base is produced by mechanical foaming, preferably, a resin composition containing a heat-absorbing agent and the emulsion resin described above can be mechanically foamed, then applied or poured into a mold, and dried. In preparation of the foam base, the resin composition may be cured by heat, ultraviolet light, or the like, if necessary, after drying.

On the other hand, when the foam base is produced by chemical foaming, for example, an exemplary method includes the steps of: producing a polyolefin resin sheet by feeding a polyolefin resin composition containing a polyolefin resin containing 40% by weight or more of a polyethylene resin, a thermal decomposition-type foaming agent, a foaming aid, a colorant, and other components if necessary, to an extruder, melting and kneading, and extruding a sheet from the extruder; and foaming the thermal decomposition-type foaming agent in the polyolefin resin sheet.

If necessary, as described later, the method may include the step of cross-linking the polyolefin resin sheet, or the step of drawing the foam sheet by melting or softening the resulting foam sheet and drawing it in one or both of the flow direction and the width direction.

As the thermal decomposition-type foaming agent, known compounds conventionally used for foam production, such as azodicarbonamide, N,N′-dinitrosopentamethylenetetetramine, and p-toluenesulfonyl semicarbazide, can be used singly or in combination of two or more without limitation. Among these, azodicarbonamide is preferred. The amount of the thermal decomposition-type foaming agent added may be determined as appropriate according to the expansion ratio of the polyolefin foam, and the amount added is preferably 1 part by mass to 40 parts by mass per 100 parts by mass of the polyolefin resin and more preferably 1 part by mass to 30 parts by mass, in terms of easily adjusting the expansion ratio, the tensile strength, the compression recovery rate, and the like to the desired range.

The thermal decomposition-type foaming agent in the polyolefin resin sheet can be foamed by any method without limitation. Examples of the method include heating by hot air, heating by infrared rays, heating in a salt bath or an oil bath, and these methods may be used in combination. Among these methods, heating by hot air or infrared rays is preferred because if so, there is little difference in appearance between the front surface and the back surface of the polyolefin foam.

The foam base may have a crosslinking structure. For example, when a polyolefin foam is produced by foaming the polyolefin resin sheet with the thermal decomposition-type foaming agent or the like, it is preferable to design the foam base so that the crosslinking structure described above is formed. The degree of crosslinking is preferably in the range of 5% by mass to 60% by mass, and more preferably in the range of 10% by mass to 55% by mass, in terms of preventing surface roughness caused by broken bubbles that may be formed near the surface of the foam base, and further improving good adhesiveness between the foam layer (C) and the adhesive layer (B) in the present adhesive tape and the impact resistance of the present adhesive tape.

The degree of crosslinking can be measured as follows. A set of five sheets of 40 mm×50 mm square foam base is used as a sample, and the total mass (G1) thereof is measured. The sample is then immersed in xylene at 120° C. for 24 hours, then the xylene-insoluble portion is separated by filtration through a 300-mesh wire cloth, and the mass (G2) of the residue is measured after drying at 110° C. for one hour. The xylene-insoluble portion determined according to the following formula is defined as the degree of crosslinking.

$$Degree of crosslinking ( \% by mass ) = ( G 2 / G 1 ) \times 100$$

The method of crosslinking the foam base is not limited. For example, when the polyolefin foam described above is crosslinked, examples of the method include irradiating the polyolefin foam with ionizing radiation, or blending an organic peroxide in advance in the polyolefin resin composition and heating the resulting polyolefin foam to decompose the organic peroxide. These methods may be used in combination.

Examples of the ionizing radiation include electron beams, alpha rays, beta rays, and gamma rays. The dose of ionizing radiation is adjusted as appropriate such that the degree of crosslinking of the polyolefin foam falls within the preferred range above. Typically, a range of 5 kGy to 200 kGy is preferred. It is preferable to irradiate both surfaces of the polyolefin foam with ionizing radiation in terms of achieving a uniform foamed state, and it is more preferable to irradiate both surfaces with the same dose.

Examples of the organic peroxide include 1,1-bis(t-butylperoxy)3,3,5-trimethylcyclohexane, 1,1-bis(t-butylperoxy)cyclohexane, 2,2-bis(t-butylperoxy)octane, n-butyl-4,4-bis(t-butylperoxy)valerate, di-t-butyl peroxide, t-butylcumyl peroxide, dicumyl peroxide, α,α′-bis(t-butylperoxy-m-isopropyl)benzene, 2,5-dimethyl-2,5-di(t-butylperoxy)hexane, 2,5-dimethyl-2,5-di(t-butylperoxy)hexyne-3, benzoyl peroxide, cumyl peroxyneodecanoate, t-butyl peroxybenzoate, 2,5-dimethyl-2,5-di(benzoylperoxy)hexane, t-butylperoxyisopropyl carbonate, and t-butyl peroxy allyl carbonate. These may be used singly or in combination of two or more. When the organic peroxide is blended in advance, the amount blended is preferably in the range of 0.01 parts by mass to 5 parts by mass per 100 parts by mass of the polyolefin resin, and more preferably in the range of 0.1 parts by mass to 3 parts by mass in terms of suppressing residual decomposition residue of the organic peroxide.

The foam base may be drawn. The drawing may be performed after the polyolefin resin sheet is foamed to produce a polyolefin foam, or may be performed when the polyolefin resin sheet is foamed.

When the drawing is performed after the polyolefin resin sheet is foamed to produce a polyolefin foam, the drawing may be performed continuously while the molten state at the time of foaming is kept without cooling the foam, or the drawing may be performed after the resulting polyolefin foam is cooled and then heated again into a molten or softened state. Here, the molten state of the polyolefin foam refers to a state in which such a foam is heated above the melting point of the polyolefin resin that constitutes the foam. The softened state of the polyolefin foam refers to a state in which the foam is heated to a temperature equal to or higher than the softening point and lower than the melting point of the polyolefin resin that constitutes such a foam. The drawing allows the bubbles in the foam to be drawn and deformed in a predetermined direction, resulting in a polyolefin foam with a bubble aspect ratio within a predetermined range.

The drawing direction of the foam base is preferably the flow direction or the width direction of the elongated polyolefin resin sheet or may be the flow direction and the width direction. When the foam base is drawn in the flow direction and the width direction, the foam base may be drawn in the flow direction and the width direction simultaneously or may be drawn separately in one direction.

Examples of the method of drawing the foam base in the flow direction include a method in which the foam base is drawn in the flow direction by winding up the elongated polyolefin resin sheet while cooling after foaming, at a speed (take-up speed) higher than the speed of feeding the elongated polyolefin resin sheet to the foaming step (feed speed), and a method in which the foam base is drawn in the flow direction by winding up the foam base at a speed (take-up speed) higher than the speed of feeding the resulting foam base to the drawing step (feed speed). Since the polyolefin resin sheet tends to expand in the flow direction due to its own foaming, it is preferable that the amount of expansion in the flow direction due to foaming of the polyolefin resin sheet is taken into consideration when the foam base obtained using the polyolefin resin sheet is drawn in the flow direction, and the feed speed and the take-up speed of the foam base are adjusted such that the foam base is drawn in the flow direction more than the amount of expansion.

A preferred method of drawing the foam base in the width direction is a method in which the foam base is drawn in the width direction by gripping both ends in the width direction of the foam base with a pair of grippers and gradually moving the grippers in a direction away from each other. Since the polyolefin resin sheet expands in the width direction due to its own foaming, it is preferable that the amount of expansion in the width direction due to foaming of the polyolefin resin sheet is taken into consideration when the foam base is drawn in the width direction, and adjustment is made such that the foam base is drawn in the width direction more than the amount of expansion.

The drawing ratio in the flow direction of the foam base is preferably 1.1 to 2.0 and more preferably 1.2 to 1.5. The drawing ratio in the width direction of the foam base is preferably 1.2 to 4.5 and more preferably 1.5 to 3.5.

The foam base may be subjected to surface treatment such as corona treatment, flame treatment, plasma treatment, hot air treatment, ozone treatment, ultraviolet treatment, or adhesion-improving treatment in order to enhance adhesiveness to the adhesive layer (B) or another layer. The wetting index with a wetting agent of the surface of such a surface-treated foam base is preferably 36 mN/m or more, preferably 40 mN/m or more, and even more preferably 48 mN/m or more, in terms of maintaining satisfactory adhesiveness to the adhesive layer (B) and the like.

### [Base Film Layer (D)]

When an article having two or more adherends fixed by the present adhesive tape is dismantled, the adhesive layer (B) and the foam layer (C) that constitute the present adhesive tape may remain on the surface of the adherend, and it may be difficult to remove the residue of the present adhesive tape on the adherend. When the present adhesive tape is in the form of having the base film layer (D) preferably between the easily dismantlable layer (A) and the adhesive layer (B), the base film layer (D) functions as a support when the residue of the present adhesive tape remaining on the adherend is removed, and the residue can be easily removed from the surface of the adherend by pulling the residue including the adhesive layer (B), the foam layer (C), and the base film layer (D).

The thickness of the base film layer (D) is preferably in the range of 0.5 μm to 40 μm in terms of impact resistance and conformability to the adherend of the present adhesive tape, and achieving satisfactory removability of the residue of the present adhesive tape from the adherend surface, more preferably in the range of 2 μm to 25 μm, even more preferably in the range of 3 μm to 20 μm, and particularly preferably in the range of 3 μm to 16 μm.

Examples of the base film layer (D) include resin films made of polyester (polyethylene terephthalate, polybutylene terephthalate, polyethylene naphthalate, etc.), polyolefin (polyethylene, polypropylene, polymethylpentene, etc.), cellophane, diacetyl cellulose, triacetyl cellulose, acetyl cellulose butyrate, polyvinyl chloride, polyvinylidene chloride, polyvinyl alcohol, ethylene-vinyl acetate copolymer, polystyrene, polycarbonate, polysulfone, polyetheretherketone, polyethersulfone, polyetherimide, polyimide, fluororesin, polyamide resin, acrylic resin, urethane resin, or the like; and non-woven fabric, paper, or cloth, made of pulp, rayon, Manila hemp, acrylonitrile, nylon, polyester, or the like, or metal foil.

The base film layer (D) can serve as a support when the residue of the present adhesive tape is removed from the adherends fixed by the present adhesive tape after the adherends are dismantled from each other and the easily dismantlable layer is broken. Thus, in terms of easily achieving compatibility between adhesion of the base film layer to other layers of the present adhesive tape and strength as a support, it is preferable to use a resin film as the base film layer (D), and it is more preferable to use a polyester film as the base film layer (D).

These resin films may be subjected to surface treatment such as corona treatment, flame treatment, plasma treatment, hot air treatment, ozone treatment, ultraviolet treatment, or application of an adhesion-improving agent on one side or both sides of the resin film, in order to enhance adhesiveness to other layers such as the foam layer (C) and the adhesive layer (B).

The resin film may be colored with a pigment or dye. Using a colored resin film as the base film layer (D) makes it easy to identify the front and back of the present adhesive tape.

The base film layer (D) may contain the heat-absorbing agent described above.

### [Bonding Agent Layer (E)]

In terms of further improving the adhesiveness between the layers that constitute the present adhesive tape, the present adhesive tape may have a bonding agent layer (E). The bonding agent layer (E) can, for example, bond the easily dismantlable layer (A) and the foam layer (C) when neither has adhesive properties.

The thickness of the bonding agent layer (E) is preferably 10 μm or less and more preferably in the range of 1 μm to 5 μm.

Examples of a bonding agent that can form the bonding agent layer (E) include urethane resin-based bonding agents, acrylic resin-based bonding agents, and polyester resin-based bonding agents. Among these, urethane resin-based bonding agents are preferred, and urethane resin-based bonding agents containing a polyether-based urethane resin or a polyester-based urethane resin are more preferred. It is particularly preferable to use a urethane resin-based bonding agent containing a polyether-based urethane resin because the initial bonding strength is excellent and the layers can be laminated at a relatively low temperature even when a dry lamination method is used to produce the present adhesive tape.

The bonding agent layer (E) may contain the heat-absorbing agent described above.

### [Method of Producing Adhesive Tape of Present Invention]

The method of producing the present adhesive tape is not limited.

For example, the present adhesive tape of a first embodiment described above can be produced through the steps of: forming the adhesive layer (b1) and the adhesive layer (b2) as the adhesive layer (B), for example, by applying and drying the adhesive described above on a surface of a release sheet; forming the easily dismantlable layer (A), for example, by applying and drying a thermoplastic resin composition for forming the easily dismantlable layer (A) on one side of the foam base described above; and transferring the adhesive layer (b1) and the adhesive layer (b2) prepared in advance respectively to the other side of the foam base described above and to a surface of the easily dismantlable layer (A). The present adhesive tape can also be produced by directly applying and drying the adhesive described above on the surfaces of the foam base and the easily dismantlable layer (A) to form the adhesive layer (b1) and the adhesive layer (b2) as the adhesive layer (B).

The present adhesive tape of a second embodiment can be produced, for example, by forming the easily dismantlable layer (A), for example, by applying and drying the thermoplastic resin composition on a surface of a resin film as the base film layer (D), forming the foam layer (C) by bonding the foam base to a surface of the easily dismantlable layer (A), using the bonding agent described above as the bonding agent layer (E) if necessary, and transferring the adhesive layer (b1) and the adhesive layer (b2) produced in advance respectively to a surface of the foam base and the back surface of the resin film.

The present adhesive tape of a third embodiment can be produced, for example, by forming the easily dismantlable layer (A), for example, by applying and drying the thermoplastic resin composition on a surface of a resin film as the base film layer (D), forming the foam layer (C) by bonding the foam base to a surface of the easily dismantlable layer (A), using the bonding agent described above as the bonding agent layer (E) if necessary, bonding a resin film to a surface of the foam base using the bonding agent described above as the bonding agent layer (E) if necessary, and transferring the adhesive layer (b1) and the adhesive layer (b2) produced in advance respectively to the surfaces of the two resin films.

A release sheet may be attached to the surfaces of the adhesive layer (b1) and the adhesive layer (b2) that constitute the present adhesive tape in the form of a double-sided adhesive tape, if necessary. Examples of the release sheet include glassine paper, kraft paper, clay-coated paper, paper laminated with polyethylene or other films, paper coated with polyvinyl alcohol, acrylic ester copolymer or other resins, and polyester, polypropylene, or other synthetic resin films coated with a release agent such as fluororesin or silicone resin.

### [Usage of Adhesive Tape of Present Invention]

The present adhesive tape can be suitably used for fixing various adherends, for example, rigid material to rigid material. For example, examples of rigid adherends include metal adherends such as metal sheets, metal housings, and metal covers, glass sheets, and plastic sheets. Among these, the present adhesive tape is preferred for use on metal adherends which transfer heat relatively easily.

The adherends to be fixed by the present adhesive tape preferably in the form of double-sided adhesive tape may be the same type of adherends or different types of adherends.

In the present adhesive tape, the easily dismantlable layer (A) is easily broken by heating. Thus, in terms of facilitating separation of a large number of parts when reusing or recycling parts of various products in industrial applications such as automobile, construction materials, OA, and home appliance industries, the present adhesive tape can be suitably used as a double-sided adhesive tape to fix these parts.

Further, when applied to labels and other applications, the present adhesive tape provides good operation efficiency in removing a large number of labels.

An article having a configuration obtained by fixing two or more adherends by the present adhesive tape are unable to be easily separated or dismantled under normal conditions, specifically, in a normal temperature environment. On the other hand, two or more adherends that constitute the article can be separated by directly or indirectly heating the article, a part or all of the present adhesive tape or the easily dismantlable layer (A) that constitutes the article and thereby plasticizing the easily dismantlable layer (A), causing material fracture of the easily dismantlable layer (A). The heating may be performed by heating the article and the present adhesive tape as a whole, and when the easily dismantlable layer (A) is softened by heat, a peel stress can be applied to the present adhesive tape by applying force to the present adhesive tape in a direction that separates two or more adherends.

The present adhesive tape is heated preferably on a surface closer to the easily dismantlable layer (A) that constitutes the adhesive tape. The heating may be at any temperature that can implement satisfactory dismantling property, preferably 60° C. to 180° C., more preferably 80° C. to 150° C., even more preferably 80° C. to 130° C., and particularly preferably 100° C. to 130° C.

The present adhesive tape can also enable the dismantling of an article having a configuration obtained by fixing with the present adhesive tape, at a relatively low heating temperature as described above. Thus, in particular, the present adhesive tape can be suitably used as an adhesive tape for fixing parts of electrical products such as mobile phones, video equipment, and computers, whose parts may be degraded by heat. The present adhesive tape can also be suitably used for label applications that can be easily removed by heating, and as a dicing tape that constitutes a dicing die bond film used in manufacture of semiconductor integrated circuits.

### EXAMPLES

The present invention will be described more specifically with examples. However, the present invention is not limited to the following examples. The compounds used in the examples and the like are listed below.

### <Resin>

Resin 1: “VONCOAT 5400EF” (product name, water-dispersed acrylic resin emulsion, non-volatile content 50%, available from DIC Corporation) <Foam Stabilizer> foam stabilizer 1: “DICNAL M-40” (product name, sulfonic acid-type anionic surfactant, available from DIC Corporation) <Crosslinking Agent> crosslinking agent 1: “DICNAL GX” (product name, oxazoline group-containing polymer, available from DIC Corporation) <Heat-Absorbing Agent> aluminum hydroxide: (product name “Aluminum hydroxide Cica Grade 1”, available from KANTO CHEMICAL CO., INC.), calcium sulfate dihydrate: (product name “Calcium sulfate dihydrate, special grade”, available from KANTO CHEMICAL CO., INC.), sodium hydrogen carbonate: (product name “Sodium hydrogen carbonate, special grade”, available from KANTO CHEMICAL CO., INC.)

### Preparation Example 1

### <Acrylic Polymer for Forming Adhesive Layer (A-1)>

In a reaction vessel equipped with a stirrer, a reflux condenser, a nitrogen inlet tube, and a thermometer, 80.94 parts by mass of n-butyl acrylate, 5 parts by mass of 2-ethylhexyl acrylate, 10 parts by mass of cyclohexyl acrylate, 4 parts by mass of acrylic acid, 0.06 parts by mass of 4-hydroxybutyl acrylate, and 200 parts by mass of ethyl acetate were charged, and the temperature was raised to 72° C. with nitrogen blown in with stirring. Then, 2 parts by mass of a solution of 2,2′-azobis(2-methylbutyronitrile) (solid content 0.1% by mass) dissolved in advance in ethyl acetate was added, and the mixture was stirred at 72° C. for 4 hours, and then stirred at 75° C. for 5 hours.

The resulting reaction mixture was diluted with 98 parts by mass of ethyl acetate and filtered through a 200-mesh wire cloth to yield an acrylic polymer (A-1) solution with a weight average molecular weight of 1,600,000 (non-volatile content of 40% by mass).

The weight average molecular weight was the weight average molecular weight in terms of standard polystyrene as measured by gel permeation chromatography (GPC) and was measured by the following method.
System: GPC system from Tosoh Corporation “HLC-8329GPC”
Sample concentration: 0.5% by mass—tetrahydrofuran solution
Sample injection volume: 100 μl
Eluent: tetrahydrofuran
Flow rate: 1.0 ml/min
Measuring temperature: 40° C.
Main columns: TSKgel GMHHR-H (20)×2
Guard column: TSKgel HXL-H
Detector: differential refractometer
Molecular weight of standard polystyrene: 10,000 to 20,000,000 (from Tosoh Corporation)

### Preparation Example 2

### <Thermoplastic Resin Composition for Forming Easily Dismantlable Layer>

A thermoplastic resin composition for forming an easily dismantlable layer was obtained by dissolving in toluene 100 parts by mass of a styrene-isoprene block copolymer with a weight average molecular weight of 200,000 [a mixture of a triblock copolymer and a diblock copolymer (diblock copolymer 52% by mass): styrene unit content 15% by mass, isoprene unit content 85% by mass], 40 parts by mass of a C5 petroleum-based tackifier resin (softening point 100° C., number average molecular weight 885), 30 parts by mass of a polymerized rosin ester-based tackifier resin (softening point 125° C., number average molecular weight 880), and 5 parts by mass of HV-100 (JX Nippon Oil & energy Corporation, low molecular weight polybutene) as a liquid tackifier resin.

### Example 1

(1) In a container, to 100 parts by mass of the acrylic polymer (A-1), 15 parts by mass of polymerized rosin ester-based tackifier resin D-125 (from ARAKAWA CHEMICAL INDUSTRIES, LTD.) and 10 parts by mass of disproportionated rosin ester-based tackifier resin A-125 (from ARAKAWA CHEMICAL INDUSTRIES, LTD.) were mixed and stirred, and then ethyl acetate was added to yield an adhesive solution with a solid content of 31% by mass.

To 100 parts by mass of the adhesive solution, 1.4 parts by mass of BURNOCK D-40 (from DIC Corporation, trimethylolpropane adduct of tolylene diisocyanate, isocyanate group content of 7% by mass, non-volatile content of 40% by mass) was added as a crosslinking agent and mixed by stirring to be homogeneous. The mixture was then filtered through a 100-mesh wire cloth to yield an adhesive (p-1).

The resulting adhesive (p-1) was applied to a release-treated surface of a release sheet so that the thickness of the adhesive layer after drying was 20 μm, and dried at 80° C. for 3 minutes to produce an adhesive layer.

The adhesive (p-1) was also applied to a release-treated surface of a release sheet different from the above so that the thickness of the adhesive layer after drying was 20 μm, and dried at 80° C. for 3 minutes to produce an adhesive layer.

(2) 100 parts by mass of the resin 1 (water-dispersed acrylic resin emulsion), 6 parts by mass of the foam stabilizer 1 (sulfonic acid-type anionic surfactant), and 3 parts by mass of the crosslinking agent 1 (oxazoline group-containing polymer) were prepared and mixed by stirring (2000 rpm, 3 minutes) using a disperser to produce a binder for mechanical foaming. The prepared binder was stirred and foamed with a foaming ratio of 2, and 240 parts by mass of aluminum hydroxide as a heat-absorbing agent was added to the foamed binder, which was continuously stirred for another 5 minutes to obtain a foamable mixture.

The resulting foamable mixture was applied with an applicator on a polyethylene terephthalate (PET) film. Then, after heating at 105° C. for 5 minutes as pre-drying, the film was heated at 120° C. for 3 minutes, turned over, and further heated at 120° C. for 3 minutes for curing, resulting in a foam base 1 with a thickness of 1 mm.

The foam base 1 had a specific gravity of 0.64 and a mass of 640 g/m², and the mass of the heat-absorbing agent in the foam base 1 was 514 g/m². The cross section of the cut foam sheet 1 was observed with an electron microscope (digital microscope VHX-900 from KEYENCE CORPORATION).

(3) On one side of the foam base 1 obtained in (2) above, the thermoplastic resin composition for forming an easily dismantlable layer obtained in Preparation Example 2 was applied and dried to form an easily dismantlable layer. Subsequently, a resin film of polyethylene terephthalate (6-μm thick) was attached to a surface of this easily dismantlable layer as a base film layer to prepare a laminate 1 in which the foam base 1 and the resin film were bonded with the 4-μm thick easily dismantlable layer interposed. (4) The adhesive layers prepared in advance using the adhesive (p-1) in (1) above were attached to a surface of the foam layer of the foam base 1 and to a surface of the resin film layer in the laminate 1. This was laminated at 23° C. using a roll with a linear pressure of 5 kg/cm. The laminated product was then aged for 48 hours at 40° C., resulting in a 150-μm thick double-sided adhesive tape 1.

### Examples 2 to 4, Comparative Example 1

Double-sided adhesive tapes 2 to 5 were produced in the same manner as in Example 1, except that the kinds and amounts of the resin 1, the foam stabilizer 1, the crosslinking agent 1, and the heat-absorbing agent were as listed in Table 1 as in (2) of Example 1, to obtain foam bases 2 to 5.

### 2. Evaluation of Foam Bases 1 to 5

### 2-1. Formability

At 23° C. in the air, each foam base was wrapped around a 10-mm diameter rod and visually checked for cracks on the sheet surface. The results are listed in Table 1.

### [Evaluation Criteria]

A: No cracks observed
C: Cracks observed

### 2-2. Endothermic Characteristics

The endothermic start temperature and the endothermic peak temperature were measured for the foam bases 1 to 4 as follows. The temperature was increased from 0° C. to 350° C. at 1° C./min under a nitrogen atmosphere using a differential scanning calorimeter (DSC; DSC-7020 from Hitachi High-Tech Corporation). The temperature at which the rising of melting peak from the baseline of the DSC measurement curve started was set as the endothermic start temperature (° C.), and the point of maximum difference from the baseline of the DSC measurement curve was set as the endothermic peak temperature (° C.). The integral value of the endothermic peak with respect to the baseline of the DSC measurement curve was divided by the mass of the heat-absorbing agent used in the measurement to obtain the endothermic amount (J/g).

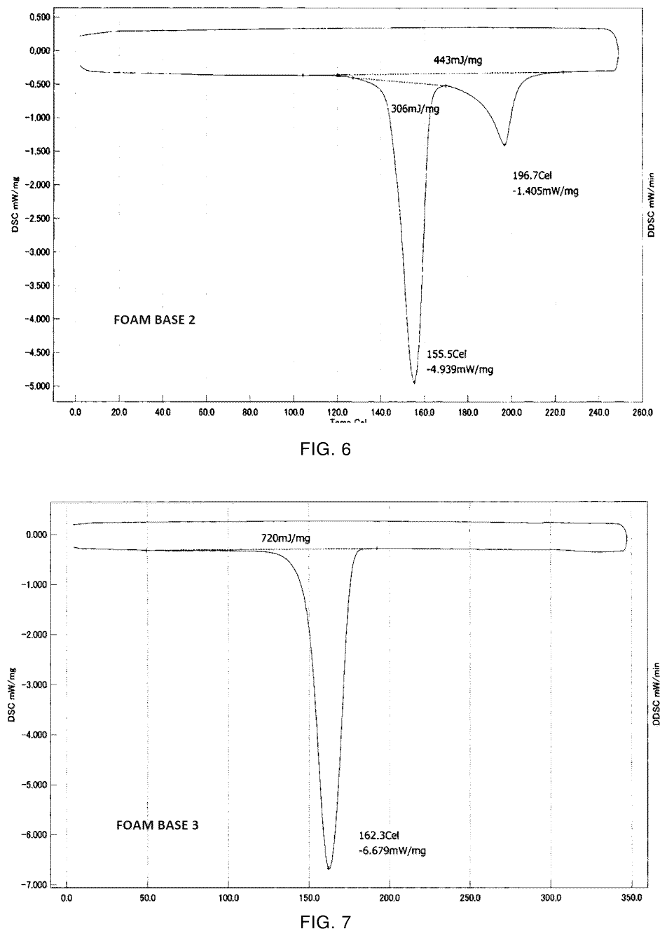

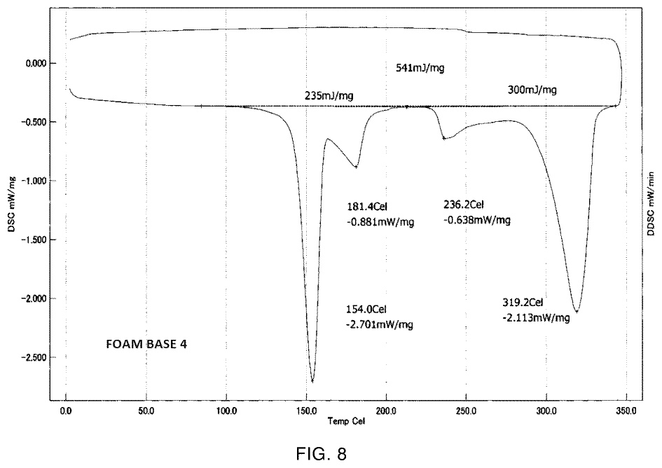

The respective DSC curves of the foam bases are provided in FIG. 5 to FIG. 8.

TABLE 1

| | | | Ex. | Ex. | Ex. | Ex. | Comp. |
|---|---|---|---|---|---|---|---|
| | | | 1 | 2 | 3 | 4 | Ex. 1 |
| Foam | Resin 1 | Water-dispersed acrylic | 100 | 100 | 100 | 100 | 100 |
| base | | resin emulsion | | | | | |
| constituents | Foam stabilizer 1 | DICNAL M-40 | 6 | 6 | 6 | 6 | 6 |
| | Crosslinking agent 1 | DICNAL GX | 3 | 3 | 3 | 3 | 3 |
| | Heat-absorbing agent | Aluminum hydroxide | 240 | | | 70 | |
| | | Calcium sulfate dihydrate | | 110 | | 70 | |
| | | Sodium hydrogen carbonate | | | 450 | | |
| Characteristics | Characteristics of | Endothermic start | 230 | 120 | 100 | 120 | |
| | foam base (DSC) | temperature 1 (° C.) | | | | | |
| | | Endothermic peak | 320 | 156 | 162 | 156 | |
| | | temperature 1 (° C.) | | | | | |
| | | Endothermic amount 1 | 683 | 443 | 720 | 235 | |
| | | (J/g) | | | | | |
| | | Endothermic start | | | | 230 | |
| | | temperature 2 (° C.) | | | | | |
| | | Endothermic peak | | | | 320 | |
| | | temperature 2 (° C.) | | | | | |
| | | Endothermic amount 2 | | | | 300 | |
| | | (J/g) | | | | | |

| | | | | | |
|---|---|---|---|---|---|
| Formability | A | A | A | A | A |

The numerals in the constituent fields mean parts by mass.

### INDUSTRIAL APPLICABILITY

The adhesive tape of the present invention has excellent formability, impact resistance, conformability to adherends, and endothermic property, and can suppress thermal degradation of adherends in particular even when excessive heat is applied. The adhesive tape of the present invention can be used to fix two or more adherends and can be easily dismantled when the adherends are separated, and therefore the adhesive tape of the present invention is useful, for example, for fixing electronic device parts such as protective panels for image displays, image display modules, touch panels, and thin batteries, and the main bodies (housings) of electronic devices.

### REFERENCE SIGNS LIST

1 adhesive layer
2 foam layer
3 easily dismantlable layer
4 base film layer
5 bonding agent layer

1. An adhesive tape comprising:
an easily dismantlable layer (A) containing a thermoplastic resin;
an adhesive layer (B); and
a foam layer (C), wherein
one or more layers of the easily dismantlable layer (A), the foam layer (C), and the adhesive layer (B) contain one or more heat-absorbing agents.

2. The adhesive tape according to claim 1, wherein the foam layer (C) contains one or more heat-absorbing agents.

3. The adhesive tape according to claim 1, wherein the adhesive tape comprises a foam layer (C) and an adhesive layer (b1) on one side of the easily dismantlable layer (A) directly or with another layer interposed, and comprises an adhesive layer (b2) on the other side of the easily dismantlable layer (A) directly or with another layer interposed.

4. The adhesive tape according to claim 1, wherein the adhesive tape comprises an adhesive layer (b2) on the other side of the easily dismantlable layer (A) at least with a base film layer (D) interposed.

5. The adhesive tape according to claim 1, wherein a foam layer (C) is laminated directly or with another layer interposed on one side of the easily dismantlable layer (A), an adhesive layer (b1) is laminated on a surface of the foam layer (C) with at least one layer of a base film layer (D) and a bonding agent layer (E) interposed, and the adhesive tape has an adhesive layer (b2) with at least one layer of the base film layer (D) and the bonding agent layer (E) interposed on the other side of the easily dismantlable layer (A).

6. The adhesive tape according to claim 1, wherein the foam layer (C) has a thickness of 1500 μm or less.

7. The adhesive tape according to claim 1, wherein the adhesive tape has a total thickness of 100 μm to 500 μm.

8. An article comprising a configuration in which two or more adherends are fixed by the adhesive tape according to claim 1.

9. A method for dismantling an article, the method comprising separating two or more adherends that constitute the article by directly or indirectly heating a part or all of an easily dismantlable layer (A) and plasticizing the easily dismantlable layer (A).
